(19) United States
(12) Patent Application Publication
(10) Pub. No.: US 2013/0124432 A1
(43) Pub. Date: May 16, 2013

(54) SYSTEM AND METHOD FOR THE CREATION AND SALE OF SEC-COMPLIANT INVESTMENT VEHICLES

(71) Applicant: Mariner Ventures, Gloucester, MA (US)

(72) Inventor: Robert J. Thibodeau, Gloucester, MA (US)

(73) Assignee: Mariner Ventures, Gloucester, MA (US)

(21) Appl. No.: 13/667,464

(22) Filed: Nov. 2, 2012

Related U.S. Application Data
(60) Provisional application No. 61/554,823, filed on Nov. 2, 2011.

(51) Int. Cl. G06Q 40/06

(52) U.S. Cl. CPC G06Q 40/06
USPC 705/36 R

(57) ABSTRACT

A system and method are disclosed for raising financing in accordance with SEC and other regulatory requirements by an early stage company. Initially, a draft business plan is presented to collaborators, on a company's Internet website, and interested potential collaborators of the company are allowed to collaborate and assist in the development and refinement of the business plan, invite other prospective collaborators likewise to collaborate on the plans development. At such point as the business plan receives enough such indications of positive interest from collaborators, the company may elect to package the business plan elements into a securities offering as may be determined suitable by the company based on the number, qualifications, and geographic locations of collaborators who have indicated a willingness and a desire to invest in the company which they have helped to create.

### BACKGROUND

Historically, raising money for an early stage company has been accomplished by soliciting direct family and friends, and professional and collegiate affiliations. Resulting from the means of communication available, such efforts were confined to small geographic areas, and limited further by concepts of social mobility. Starting in 1946 and continuing to the present day, the advent of venture capitalism created a new mechanism for early stage companies to raise money, organized pools of investment capital managed by professionals (Venture Capitalists, see Brigadier General George Doriot, ARDC 1946). Under venture capitalism, institutional investors pool their money together with high net worth individuals into investment partnerships, which are in turn managed by active partners. It is the job of these partners to seek out investment opportunities, to effect investments therein, and assist in the maturation of invested companies. (According to the National Venture Capital Association, there were 476 active professional venture capital firms in the United States in 2010 investing approximately $22 billion into nearly 2,749 companies. Of these, 1,001 companies received funding for the first time for an average investment of over $8,000,000 as compared to Doriot's first investment of $70,000 in Digital Equipment Corp.) As the venture capital industry grew in terms of numbers and in terms of amount invested per company, this left smaller companies with little opportunity to attract the attention of venture capitalists. As these numbers indicate, the average size of the investment has increased dramatically, and while 2750 companies may seem significant, it is insignificant when compared with the total number of new companies started in the US annually (approximately 500,000)

Rules and regulations governing capital formation by early stage companies. Under the Securities Act of 1933, any offer to sell securities must either be registered with the SEC or meet an exemption. Regulation D (or Reg D) contains three rules providing exemptions from registration requirements, allowing some companies to offer and sell their securities without having to register the securities with the SEC. While companies using a Reg D (17 CFR §230.501 et seq.) exemption do not have to register their securities and usually do not have to file reports with the SEC, they must file what's known as a “Form D” after they first sell their securities. Form D is a brief notice that includes the names and addresses of the company's executive officers and stock promoters, but contains little other information about the company. Other rules and regulations relate to a company's requirements as they relate to raising capital from investors and vary from state to state and are governed, among other things, by location of investors, qualification of investors, size of investment sought, and the number of allowable shareholders by class of investor.

In addition, there are rules against the public distribution and advertising of investment securities, which preclude the use of widely available communications media such as television, radio, and the internet including company websites, social media, and related sites.

Recently, there have been a number of systems and processes developed to create a more effective means to raise capital for early stage companies including peer to peer lending networks, and crowdfunding sites which seek to leverage public communications networks. However, despite efforts to conform these offerings to existing regulatory regimes, such efforts invariably violate one or more of these regulations as they either: present to the public investment opportunities in ways that violate public advertising and solicitation, violate investor qualifications as to sophistication, accreditation, location, or in the case of unaccredited investors the maximum allowable number of such unaccredited investors.

Each of the existing systems embodies processes substantially as follows:

1. An entrepreneur creates a business plan or pitch, uploads or otherwise presents this plan via communications media such as a website or via social media, and solicits prospective investors to invest in said project, or

2. An entrepreneur creates a summary business plan, solicits a fundraising agent such as a broker dealer to create a securities offering, and then said broker dealer offers the resulting securities to prospective investors. In either case, the substantive interaction between the entrepreneur and prospective investors is binary, they either chose to invest, or they do not.

### SUMMARY

Accordingly, the invention addresses the problems of the above described environment, and provides a system and method for creating, refining, socializing and promulgating a business opportunity, and otherwise developing early stage businesses by collaborating with one or more persons, and raising capital in a manner that is legal and compliant with established regulatory requirements as may be defined by the Securities and Exchange Commission, State Securities Regulators, and other related regulatory bodies. The invention addresses the needs of entrepreneurs, collaborators, regulators, and investors.

In one embodiment, the present system and method performs steps including receiving an entrepreneurial concept from an entrepreneur, collaborating with interested parties such as friends and family, professional advisers, and academic advisers in the development of an entity and business plan for the entity, broadcasting a request to collaborate in the further development of the concept via a social network to grow the pool of interested parties/collaborators, using the collaborating and broadcasting to (a) build relationships between the entrepreneurs and the collaborators, (b) build and refine the business plan, and (c) gauge interest of potential investors; and then creating a security to raise financing for the entity by the entrepreneur.

Some advantageous feature of the present method and system may include:

A single system that facilitates the conception, development, refinement, collaboration and socialization, and ultimately the development of regulatory compliant offering(s) capital solicitation and capture in one place.

A cost effective, easy to use, extensible system for early stage company development.

A system to control the interactions between entrepreneurs, co-founders, friends and family, stakeholders and other collaborators.

A system to Track and monitor the effectiveness of business development efforts.

A system to increase access to potential investors, and other stakeholders through the use of advanced communications networks including websites, the internet, and social networks.

A system that allows public dissemination of company development and investment considerations, to solicit quantitative and qualitative indications of interest from said public, and to create suitable investment vehicles in accordance with established rules and regulations, the needs of the company, and those of the public.

Advantages to collaborator members of the public may include:

The ability to contribute more to an early stage company's success than merely money.

The ability to influence a company's success by introducing other collaborators.

The ability to validate perceptions by engaging in discussions with other prospective investors.

Advantages to regulators may include Consolidated access and verification of investor education and knowledge of invested companies, as well as implementation of relevant investor safeguards.

### BRIEF DESCRIPTION OF THE DRAWINGS

FIG. 1 is a diagram illustrating exemplary components of the present system;

FIG. 2 is a flowchart illustrating exemplary system operation; and

FIG. 3 is a flowchart illustrating exemplary relationships between system users and general aspects of the present method.

### DETAILED DESCRIPTION

### Overview

A system and method are disclosed for raising financing in accordance with SEC and other regulatory requirements by an early stage company. Initially, a draft business plan is presented to collaborators, on a company's Internet website, and interested potential collaborators of the company are allowed to collaborate and assist in the development and refinement of the business plan, invite other prospective collaborators likewise to collaborate on the plans development. Accompanying the business plan are collaborator sentiment indicators, which includes an opportunity to participate by ‘voting’ for certain options related to the business plan's development, as well as the opportunity to review the various facets of the business plan via transmission over the Internet.

At such point as the business plan receives enough such indications of positive interest from collaborators, the company may elect to package the business plan elements into a securities offering as may be determined suitable by the company based on the number, qualifications, and geographic locations of collaborators who have indicated a willingness and a desire to invest in the company which they have helped to create. The purchase of a company's securities shall in fact be treated in the same manner as the sale of such security to a company insider.

The stock purchase is effected preferably by an electronic fund transfer, such as by the entering of bank account number via the Web site. A security is not created until such time as there is a sufficient and significant relationship between the founding entrepreneur and all participating collaborators. As such, there is no general solicitation or advertisement, and all such knowledgeable collaborators are de facto company insiders as may qualify under certain SEC and state securities regulatory entity's exempt and or non-exempt offering qualifications.

### System Components

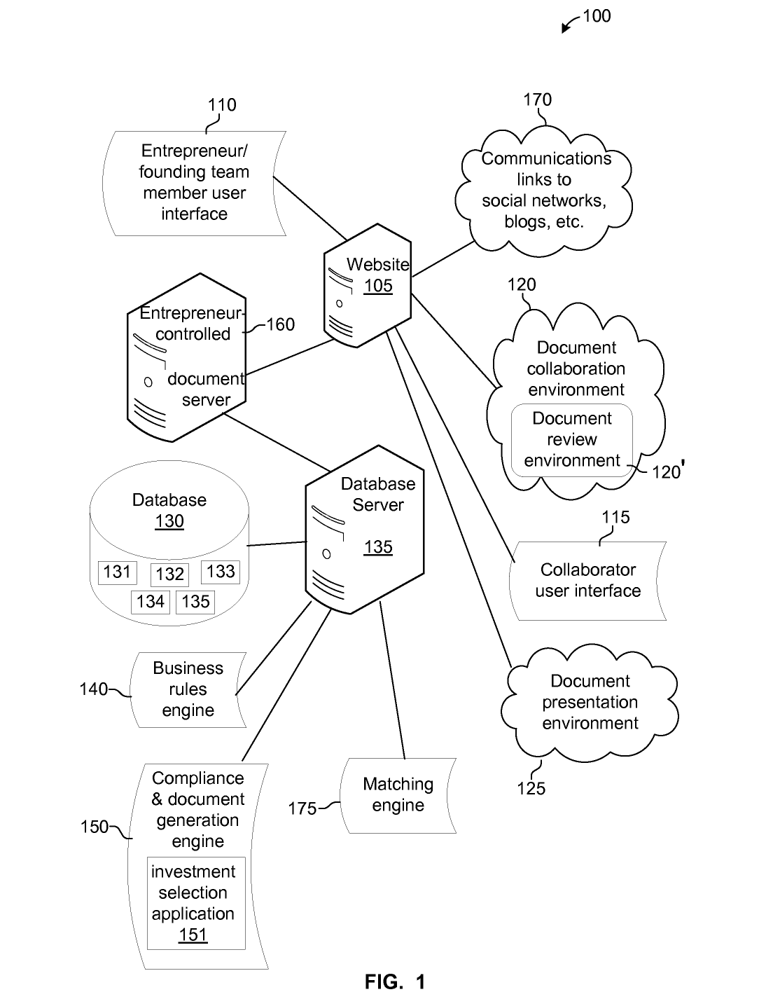

FIG. 1 is a diagram illustrating exemplary components of the present system 100. As shown in FIG. 1, system 100 comprises:
at least one web site 105, which provides a mechanism for communication between the various parties;
a set of user interfaces including an entrepreneur/founding team member user interface 110, and a collaborator user interface 115;
a central relational database 130 including a database server 135, wherein is stored:

a. user information 131
i. Account Information
ii. User activity

b. business plan document template library 132
i. Executive Summary
ii. Business Plan
iii. Financial Plan
iv. Presentation materials
v. Pitch Deck (a stylized investment presentation)

c. entrepreneur-sponsored business plan library 133
i. Versions
ii. Edits and Revisions

d. regulatory-prescribed document template library 134
i. Reg D
   1. 504
   2. 505
   3. 506
ii. S-1

e. one or more applications 135 that provide coordination and/or control of system functions and components. In an exemplary embodiment, database server 135 functions as a system controller to control and coordinate other system components including engines 140, 150, and 175;
a document collaboration environment 120 which allows entrepreneurs, co-founders, friends and family, to collaborate in the creation and revision of business plans and invite other inner circle participants;
a document review environment 120′ which shares some or all functionality of document collaboration environment 120, and which allows environment participants to impact the direction of the business plan by their indications of acceptance and sentiment.
a document presentation environment 125 which allows the entities mentioned above to review, comment, opine, assign value, and otherwise express their satisfaction and or approval of documents and their documentary components;
a business rules engine 140 to correlate the user information in a-c below relative to relevant regulatory filing allowances:
   a. Number of Investors per plan collaboration versus statutory limitations
   b. Qualification of Investors per plan collaboration results versus statutory limits
   c. Location of Investors per plan collaboration results versus statutory limits
   d. Selection of best available securities type based on % compliance with each type of offering
   e. Selection of best available security type based on cost;
a digital document generation and compliance engine 150 which takes document components from the entrepreneur user collaboration environment and assembles them together with and arranged according to the document standard required (but otherwise non-differentiated) document components from the regulatory prescribed document template library; and prefills all required account data with user information per each user. Document generator 150 automatically generates offering documents, subscription documents, and any related documents and regulatory filings required to effect a conforming exempt or non-exempt offering between the company and persons who have indicated a willingness and desire to invest in said company.
an entrepreneur-controlled document server 160 to deliver any and all relevant documents to prospective investors and relevant regulatory entities. Document server 160 provides a means for conveying said documents between the entrepreneur and other persons and the entrepreneur and regulatory entities, and the ability to enter into relevant contracts for same; and
communications and linkages 170 with any of:

a. proprietary social network

b. public social network

c. private blog

d. public blog

e. a multiplicity of communications apparatus including computers, pda's, cell phones, tablets, etc., any or all of which may communicate with the website or via a-d above. The method and system uses communication means 170, such as the Internet, to convey said documents between the entrepreneur and other persons and the entrepreneur and regulatory entities, and the ability to enter into relevant contracts between the entrepreneur/company and investors.

The present method and system may also include a ‘matching’ engine 175 that compares the information contained within the business rules engine and the information contained within the centralized database. The outputs from matching engine 175 may include indications of conformity to exempt and or non-exempt offering regulations, identification of deficient items required by the business plan to conform to such offerings, identification of relevant investment vehicle structures based on the qualifications, income or asset levels, experience, and/or geographic location of collaborators indicating a willingness to invest in said companies.

The present method and system may also include a investment selection application 151 included within the document compliance engine 150, whereby the entrepreneur may select from among the variety of compliant investment structures generated by the compliance engine.

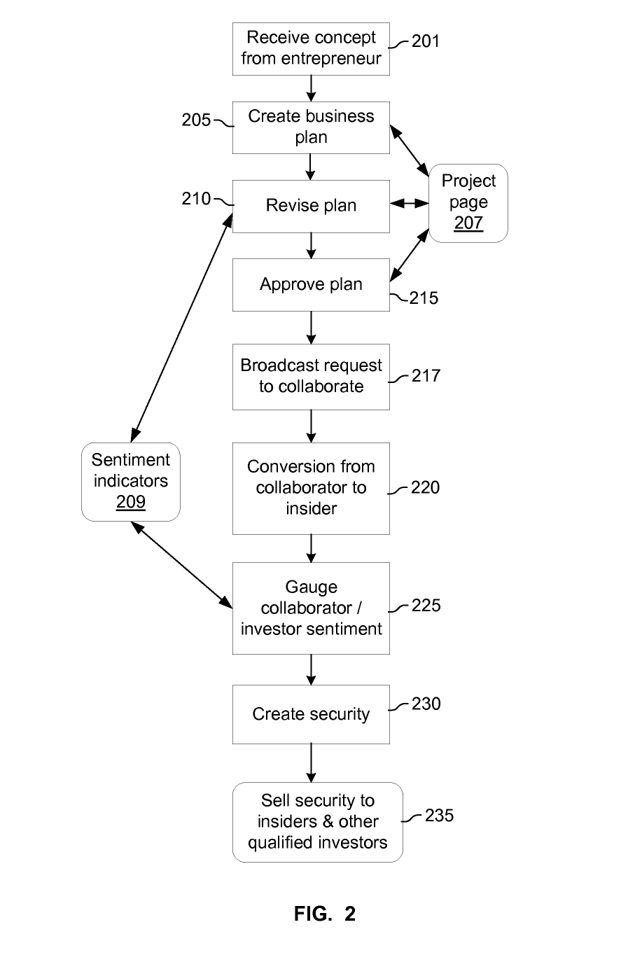

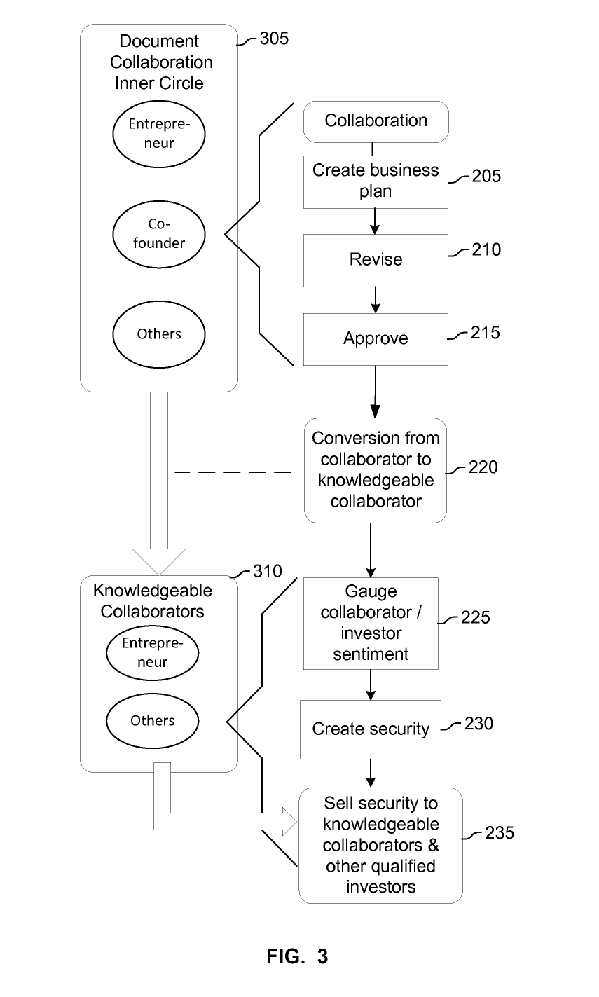

FIG. 2 is a flowchart illustrating exemplary system operation 200. FIG. 3 is a flowchart illustrating exemplary relationships between system users and certain aspects of the present method. Operation of the present system is best understood by viewing FIGS. 2 and 3 in conjunction with one another. As shown in FIGS. 2 and 3, in an exemplary embodiment, the present system and method performs steps including:

receiving an entrepreneurial concept from an entrepreneur (step 201),

collaborating with interested parties such as friends and family, professional advisers, and academic advisers (together collaborators) in the development of an entity and business plan for the entity (steps 205-215),

broadcasting a request to collaborate in the further development of the concept via a social network to grow the pool of interested parties/collaborators (step 217),

using the collaborating and broadcasting to:
build relationships between the entrepreneurs and the collaborators,
build and refine the business plan, and
gauge interest of potential investors (step 225), and

then creating a security to raise financing for the entity by the entrepreneur (step 230).

There is a state change between (a) the time a newly introduced person (i.e., an interested party) becomes a collaborator (which may occur immediately after the introduction), and (b) when, after sufficient collaboration, the collaborator becomes a ‘knowledgeable collaborator’ as defined by ‘know your client rules’ as may be adopted.

In one embodiment, the method further includes:

registering, by at least one entrepreneur, with a centralized database, at least one project concept,

sending an invitation by said entrepreneur to at least one other person to collaborate in the development of a business based on the concept,

wherein the collaborating of said person occurs with the entrepreneur in the development of the business plan;

the inviting by said person to an additional person to collaborate in the development of said business plan, and the collaboration of the additional person in the development of said company.

The method and system may also include:

searching, by any interested party, the centralized database, for the least one entrepreneur or project,

registering, by the interested party, with the centralized database,

receiving an offer to collaborate on said project by said entrepreneur,

accepting the offer and

collaborating by the interested party in the creation of said business plan.

The method and system may also include a set of user qualification and participation levels, wherein the actions required by said user to meet relevant user qualification levels are identified.

The method and system may also include the ongoing registration of willingness to invest in the project company, and the aggregation of such information such as to create a representation of all such users by age, profession, income, residence, investment experience, and other relevant information provided by said other collaborating persons.

The method and system may also include the ongoing registration of the amount that each such collaborating person would be willing to invest in each project or company.

### Document Collaboration Environment

The document collaboration environment 120 allows entrepreneurs, co-founders, friends and family, and professional advisers to perform the following functions:

The entrepreneur is allowed to post, revise, edit, and accept edits to his business plan drafts (and any and all related documents related to his business such as spreadsheets, presentations, and investor summary/pitch decks)whether they be his edits or those provided by any other member using the document collaboration environment. He may (but is not required to) grant any or all of these privileges to any other inner circle member.

Co-founders, friends and family, and professional advisers can revise, and edit, but cannot accept changes unless given such control by the founding entrepreneur.

### Document Presentation and Review Environments

The document presentation environment 125 provides evidence/tracking of the collaboration of the members and how this demonstrates and provides evidence of a relationship between the entrepreneur and the collaborator.

The document review environment 120′ does not allow users to edit the documents, it allows them to provide comments and suggestions to the inner circle members. The difference between the document collaboration environment and the document review environment is that within the document review environment, members do not actually edit the document, but rather provide comments and otherwise express their opinions through the use of sentiment indicators 209 (FIG. 2).

Either of the above environments may be achieved by analyzing and correlating the following user information:
1. A Log in the User File section of the Central database the time each user spends with an activity(via activity logging function):
   a. On plan
   b. On Topic
   c. Through time
2. A Log User activity with the database as relates his answers to specific questions (either binary or narrative) as relates to completeness of, or percentage reviewed of such plan (via component and plan attestation of review).
   a. To Complete a section, A user must provide a positive indication of plan and or plan component review. No response indicates component not reviewed.
3. A log of user sentiment per plan component or plan.
   a. User sentiment as may be expressed (as example) using a scale of 1-10, a 1 indicating this really sucks, and a 10 indicating it's as close to perfect as humanly possible).
4. A log of all edits made or suggested edits for any given document, by user.
5. A log of any and all comments made by method of conveyance of such comments (blog, email, chat room).
6. A set of more than one automated prompts triggered by relative activity of members designed to:
   a. solicit increased user activity by category or quantity of activity.
   b. Thank members for their comments and suggestions
7. A set of one or more automated group notification meters indicating top users by:
   a. Time on plan
   b. Most comments
   c. Most read by other members
8. A log of 1-5 above as relates to investor education material review.
9. A qualitative representation of the above data by:
   a. user,
   b. category of user (as determined within user information files),
   c. relative to other plans in the system.
10. A quantitative representation of the above data by.
   a. user,
   b. category of user (as determined within user information files),
   c. relative to other plans in the system.

The above functions may be initiated by function calls to from the respective database elements and tables. Sentiments expressed by the members are used by the entrepreneur to decide when a plan goes from the collaboration environment to the review environment. And then again when the plan goes from the review environment to be matched to its corresponding best available underwriting option.

### Matching Engine

Using member data (see for example, the data in the memberdata(1).xlsx spreadsheet in Table 1, and based on the investor questionnaire information contained within the database, we know that there are a total of 34 Investors, willing to invest $204,600, and that they all live in Massachusetts. Matching engine 175 then returns the following available securities offerings based on the allowances to the entrepreneur:
1. Intrastate Offering in Massachusetts, unlimited money, no qualification of investors, must live in MA.
2. Reg 504 and 505 and 506.
3. Any of the public offering vehicles.

In the illustration on sheet 2 of the memberdata(1).xlsx spreadsheet, there are 13 sophisticated investors, 26 accredited investors, and 21 unaccredited investors, willing to invest $1,148,350, living in multiple states. As such, the intrastate offering is unavailable, as is Reg d 504 (over 1 million dollars). However, Reg D numbers 505, and 506 as is Reg A, and the other non-exempt public offering vehicles.

| Name | Email | Gender | Location |
|---|---|---|---|
| Douglas Curtis | douglascurtis@verizon.net | Male | Gloucester, MA |
| Douglas Curtis | douglascurtis@verizon.net | Male | Gloucester, MA |
| Douglas Curtis | douglascurtis@verizon.net | Male | Gloucester, MA |
| Douglas Curtis | douglascurtis@verizon.net | Male | Gloucester, MA |
| Douglas Curtis | douglascurtis@verizon.net | Male | Gloucester, MA |
| Douglas Curtis | douglascurtis@verizon.net | Male | Gloucester, MA |
| Douglas Curtis | douglascurtis@verizon.net | Male | Gloucester, MA |
| Elery LeBlanc | eleblanc@turningpointsystems.com | Male | Gloucester, MA |
| Elery LeBlanc | eleblanc@turningpointsystems.com | Male | Gloucester, MA |
| Elery LeBlanc | eleblanc@turningpointsystems.com | Male | Gloucester, MA |
| Elery LeBlanc | eleblanc@turningpointsystems.com | Male | Gloucester, MA |
| Elery LeBlanc | eleblanc@turningpointsystems.com | Male | Gloucester, MA |

| Country | Zip | Age | SSN | Income | Sophisticated | Accredited |
|---|---|---|---|---|---|---|
| United States | 1930 | 49 | | 400000 | | 1 |
| United States | 1930 | 49 | | 250000 | | 1 |
| United States | 1930 | 49 | | 100000 | | |
| United States | 1930 | 49 | | 50000 | | |
| United States | 1930 | 49 | | 35000 | | |
| United States | 1930 | 49 | | 1000000 | | 1 |
| United States | 1930 | 49 | | 2500 | | |
| United States | 1930 | 65 | 003XX63XX | 400000 | | 1 |
| United States | 1930 | 65 | | 400000 | | 1 |
| United States | 1930 | 65 | | 250000 | | 1 |
| United States | 1930 | 65 | | 100000 | | 1 |
| United States | 1930 | 65 | | 50000 | | |

| | Desire to invest | Sophisticated | Accred |
|---|---|---|---|
| unaccredited | in project | in Project | in project |
| | 1 | 0 | 1 |
| | 1 | 0 | 1 |
| 1 | 1 | 0 | 0 |
| 1 | 1 | 0 | 0 |
| 1 | 0 | 0 | 0 |
| | 0 | 0 | 0 |
| 1 | 1 | 0 | 0 |
| | 0 | 0 | 0 |
| | 1 | 0 | 1 |
| | 0 | 0 | 0 |
| | 0 | 0 | 0 |
| 1 | 1 | 0 | 0 |

| unaccredited | Amount willing | Avail to invest | Investment | |
|---|---|---|---|---|
| in project | to invest | this project | Experience | |
| 0 | 50 | 50 | 25-40 | yr |
| 0 | 100 | 100 | 10-25 | yr |
| 1 | 250 | 250 | 1-5 | yr |
| 1 | 10000 | 10000 | 5-10 | yr |
| 0 | 14000 | 0 | 5-10 | yr |
| 0 | 6000 | 0 | 50-75 | yr |
| 1 | 1000 | 1000 | 40-60 | yr |
| 0 | 250 | 0 | 25-40 | yr |
| 0 | 300 | 300 | 25-40 | yr |
| 0 | 50 | 0 | 10-25 | yr |
| 0 | 100 | 0 | 1-5 | yr |
| 1 | 250 | 250 | 5-10 | yr |

| | | Receiving | Receiving |
|---|---|---|---|
| Birthdate | Date Joined | Broadcasts? | Any Emails? |
| Apr. 25, 1962 | Oct. 12, 2011 | Yes | Yes |
| Mar. 30, 1949 | Oct. 7, 2011 | Yes | Yes |
| Nov. 13, 1955 | Oct. 7, 2011 | Yes | Yes |
| Nov. 19, 1947 | Oct. 7, 2011 | Yes | Yes |
| Feb. 1, 1946 | Oct. 7, 2011 | Yes | Yes |
| Sep. 18, 1948 | Oct. 7, 2011 | Yes | Yes |
| Jun. 23, 1987 | Sep. 5, 2011 | Yes | Yes |
| Oct. 25, 1962 | Aug. 31, 2011 | Yes | Yes |
| Apr. 25, 1962 | Oct. 12, 2011 | Yes | Yes |
| Mar. 30, 1949 | Oct. 7, 2011 | Yes | Yes |
| Nov. 13, 1955 | Oct. 7, 2011 | Yes | Yes |
| Nov. 19, 1947 | Oct. 7, 2011 | Yes | Yes |

| | Which of the | |
|---|---|---|
| | following best | In which state |
| Last Visit | describes you? | are you located? |
| Oct. 12, 2011 | Inner Circle | MA |
| Oct. 7, 2011 | Entrepreneur | MA |
| Oct. 7, 2011 | Professional Adviser | MA |
| Oct. 7, 2011 | Professional Adviser | MA |
| Oct. 11, 2011 | Entrepreneur | MA |
| Oct. 12, 2011 | Professional Adviser | MA |
| Sep. 5, 2011 | Arena Member | MA |
| Oct. 18, 2011 | Entrepreneur | MA |
| Oct. 12, 2011 | Inner Circle | MA |
| Oct. 7, 2011 | Entrepreneur | MA |
| Oct. 7, 2011 | Professional Adviser | MA |
| Oct. 7, 2011 | Professional Adviser | MA |

| Sophisticated | Accredited | What is your |
|---|---|---|
| Investor | Investor | employment status? |
| | | Unemployed |
| | | Part Time |
| | | Full Time |
| | | Full Time |
| | | Full Time |
| | | Full Time |
| | | Full Time |
| | | Full Time |
| | | Unemployed |
| | | Part Time |
| | | Full Time |
| | | Full Time |

### Illustrative Use of the System

In an exemplary embodiment of the system and method, an entrepreneur registers as such on web site 105. As indicated in FIG. 2, at step 205, the entrepreneur then creates an initial business plan by downloading a business plan template from the prescribed document template library. Once the entrepreneur has downloaded a business plan template, the entrepreneur edits the template by inserting data and or information related to and descriptive of his business concept, thus creating a project page 207 for the business plan.

At step 210, the entrepreneur may also invite other collaborators, who may be co-founders, friends and family, or professional advisers, or other trusted individuals to assist in the creation and revision of such business plan and participate in the project page. Invitation may be by individual or bulk email, or by individual or bulk communication via one or more social networks feeds available to the system.

All entrepreneurs, co-founders, friends and family, and professional advisors and other trusted individuals automatically become document review environment users as well. Any member may invite other members of a similar or subordinated member level. As an example, an entrepreneur may invite another entrepreneur, a co-founder, friends and family, professional advisers, and interested persons. Only an entrepreneur or a co-founder may invite an inner circle member. Friends and Family, professional advisers, and other interested parties may suggest an inner circle member, but either an entrepreneur or a co-founder must invite such person to be an inner circle member.

Users will receive a rating indicating their member qualifications, with a rating from 1-10 based on the degree of completeness of their required voting member qualification questionnaire. For example, “1” indicates a basic user, and from 2-10 indicates various levels of account information. Any user may upgrade his member rating by filling in a more comprehensive set of member qualification questions, including name, address, home address, occupation, income, job description, education, employment history, investment experience, and other relevant information. The user rating may assist entrepreneurs to determine the value of a rated members comments, qualifications, and the beneficial nature of such members participation. Other users may use the rating to determine the value of comments and suggestions when such members communicate among themselves. Any member may communicate with any other member. Every member shall have their own homepage set up upon issuance of a user password.

No unrated member may cast a vote or indicate interest to participate in an investment. Only rated, fully qualified members may do so. An entrepreneur may exclude any subordinated member for inappropriate conduct.

In the event that said invitees accept such entrepreneurs' invitation(s), invitees may access the web site, establish a member account, and become members of the inviting entrepreneurs “inner circle” 305 (FIG. 3). The entrepreneur may grant to such inner circle members administrative privileges. Such administrative privileges may be sufficient to allow inner circle member to access his draft business plan, to read, edit, or otherwise revise the plan, to discuss (via one or more of a variety of means provided by the website such as a chat room, a blog, a member page comment, or an email or a text message, and accessed by a computer, web terminal, PDA, tablet or similar electronic communications device) the elements of the plan and or any enhancements, additions, deletions, or other proposed modifications to the draft business plan and or plan components.

The system may create a record of each action taken by such inner circle members, and record such information in a unique user data file. The system may also create a record of each action taken by all inner circle members, and records such information in an aggregated user data file. While inner circle members may propose a variety of draft plan modifications, the entrepreneur (or a co-founder if so elected) may choose to accept such proposed changes. The entrepreneur may also elect not to accept such proposed changes. To ensure fluidity and reduce the complexity of the collaborative process with multiple edits and comments, an entrepreneur may choose at any time to incorporate all accepted and non-accepted changes into a version . Upon creating a new version, the entrepreneur may notify the inner circle members of this new version. Upon being notified of a new version, inner circle members may review the revised document, indicate approval or disapproval of the newly revised version and indicate approval or disapproval of the plan and plan components.

In the event that a sufficient number of inner circle members approve of the plan and of each of the plan components (in step 215), then the entrepreneur may elect to: (1) solicit inner circle members to invite new arena members to review the plan, (2) remove the plan from the document collaboration environment and place it into the document review environment, (3) invite other members in the document review environment to review the plan, and/or (4) invite other persons to join and review the plan.

At step 220, after such time as there is a sufficient and significant relationship between the founding entrepreneur and all participating collaborators, each collaborator becomes a ‘knowledgeable collaborator’ 310 (FIG. 3), who is a de facto knowledgeable company insider. Such a ‘sufficient and significant relationship’ is established through the member having filled out all required investor account information, having answered one or more investor suitability questionnaires, and collaborated (in some way) with the entrepreneur through indications of having read and understood the documents, providing comments, providing suggested edits, etc.

Once the inner circle members have indicated their approval, and the entrepreneur has moved the plan from the document collaboration environment to the document review environment, any member of the document review environment may review and comment on the plan and the plan components, Only inner circle members may make changes to the plan. Document review members may provide their comments via email, blog, chat room or personal wall, at step 225, in document review environment 120′. Any and all user activity may be noted in the user database per above.

A security comprising the business detailed in the business plan is then created at step 230, and at step 235, the security is offered to insiders and other qualified investors.

What is claimed is:

1. A method for the creation and sale of an SEC-compliant investment vehicle comprising:
receiving, from an entrepreneur, an entrepreneurial concept for an entity;
creating and refining a business plan for the entity via collaboration among a group of collaborators; and
then creating a security to raise financing for the entity.

2. The method of claim 1, further including broadcasting a request to potentially interested parties to collaborate in the further development of the concept to form a pool of collaborators.

3. The method of claim 2, wherein the request is broadcast via a social network.

4. The method of claim 1, further including receiving indicia of sentiments expressed by the collaborators, to assist in determining when the entrepreneurial concept progresses from a collaboration environment to a review environment, and when the entrepreneurial concept goes from the review environment to the step of creating the security.

5. The method of claim 4, wherein the entrepreneurial concept is matched to a corresponding best available underwriting option

6. The method of claim 1, wherein the interest of potential investors in the investment vehicle is tallied to determine whether to create the security.

7. The method of claim 1, further including:
registering, by at least one entrepreneur, with a centralized database, at least one project concept;
sending an invitation by said entrepreneur to at least one other person to collaborate in the development of a business based on the concept;
wherein the collaborating of said person occurs with the entrepreneur in the development of a plan for said business.

8. The method of claim 1, wherein each of the collaborators becomes a ‘knowledgeable collaborator’ at such time as there is a sufficient and significant relationship between the entrepreneur and a particular collaborator, wherein said knowledgeable collaborator is a de facto knowledgeable company insider.

9. The method of claim 1, wherein the security is created only after there is a sufficient and significant relationship between the entrepreneur and all participating said collaborators.

10. The method of claim 8, wherein said sufficient and significant relationship is established as a result of the collaborator having provided required investor account information, having answered one or more investor suitability questionnaires, and having collaborated with the entrepreneur through indications thereof including one or more of (a) having read and understood the documents, (b) having provided comments on the entrepreneurial concept, and (c) having provided suggested edits.
